(19) United States
(12) Patent Application Publication
(10) Pub. No.: US 2017/0303118 A1
(43) Pub. Date: Oct. 19, 2017

(54) MANAGING DIGITAL PRE-DISTORTION TRAINING IN RADIO TRANSCEIVERS

(71) Applicant: QUALCOMM Incorporated, San Diego, CA (US)

(72) Inventors: Walid Khairy Mohamed AHMED, Tinton Falls, NJ (US); Ori AUSLENDER, Tel Aviv (IL); Victor Alexander ABRAMSKY, Edison, NJ (US)

(21) Appl. No.: 15/099,092

(22) Filed: Apr. 14, 2016

(51) Int. Cl. H04W 8/30; H04M 3/08; H04L 12/24; H04L 29/06; H04L 27/34; H04B 1/04

(52) U.S. Cl. CPC H04W 8/30; H04L 69/02; H04L 27/3411; H04M 3/085; H04L 41/069; H04B 2001/0425; H04M 2203/057

(57) ABSTRACT

Various aspects described herein relate to resolving failures in digital pre-distortion (DPD) training in wireless communications. A failure during DPD training can be identified for a transceiver. One or both of a severity of the failure or a type of the failure can be determined. It can also be determined whether to perform self-recovery from the failure to continue the DPD training based at least in part on one or both of the severity of the failure or the type of the failure.

Described herein are aspects generally related to communication systems, and more particularly, to calibrating transceivers in wireless communications.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. The wireless devices typically include a user equipment (UE), such as a mobile device, that communicate with a base station to receive access to a wireless network. Small cell base stations are provided as well to provide additional coverage areas. Small cell base stations are typically coupled to an Internet backend (e.g., at a residence, office building, etc.) and provide a front-end radio access network (RAN) interface. Some small cell base stations are capable of self-organization by adjusting transmit power when in proximity of other small cell base stations so as not to interfere with the other small cell base stations. Upon power-up or other detected events, a small cell base station may measure signals from surrounding small cell base stations and provide the signal measurements to a self-organizing algorithm, which may operate at the small cell base station or a centralized entity. Based on the signal measurements, a transmit power and/or power adjustment value is computed for the small cell base station (e.g., by a self-organizing network (SON) or other upper layer functionality), and provided to the small cell base station for adjusting its transmit power (e.g., by adjusting one or more power amplifiers of a transceiver of the small cell base station) to operate in the wireless network without causing substantial interference to neighboring small cell base stations.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for resolving failures in digital pre-distortion (DPD) training in wireless communications. The method includes identifying a failure during DPD training for a transceiver, determining one or both of a severity of the failure or a type of the failure, and performing self-recovery from the failure to continue the DPD training based at least in part on one or both of the severity of the failure or the type of the failure.

In other aspects, an apparatus for resolving failures in DPD training in wireless communications is provided. The apparatus includes a radio frequency (RF) transceiver, at least one processor communicatively coupled with the RF transceiver via a bus for communicating signals in a wireless network; a memory communicatively coupled with the at least one processor and/or the RF transceiver via the bus. The at least one processor and the memory are configured to identify a failure during DPD training for the RF transceiver, determine one or both of a severity of the failure or a type of the failure, and perform self-recovery from the failure to continue the DPD training based at least in part on one or both of the severity of the failure or the type of the failure.

In another example, an apparatus for resolving failures in digital pre-distortion (DPD) training in wireless communications is provided. The apparatus includes means for identifying a failure during DPD training for a transceiver, means for determining one or both of a severity of the failure or a type of the failure, and means for performing self-recovery from the failure to continue the DPD training based at least in part on one or both of the severity of the failure or the type of the failure.

Still in another example, a computer-readable storage medium comprising computer-executable code for resolving failures in digital pre-distortion (DPD) training in wireless communications is provided. The code includes code for identifying a failure during DPD training for a transceiver, code for determining one or both of a severity of the failure or a type of the failure, and code for performing self-recovery from the failure to continue the DPD training based at least in part on one or both of the severity of the failure or the type of the failure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system, in accordance with aspects described herein.

FIG. 2 is a diagram illustrating an example of an access network in accordance with aspects described herein.

FIG. 3 is a diagram illustrating an example of an evolved Node B and user equipment in an access network in accordance with aspects described herein.

FIG. 4 is a diagram illustrating an example system performing digital pre-distortion (DPD) training in accordance with aspects described herein.

FIGS. 5A-5C are flow charts of example methods of determining whether to self-recover from a failure in DPD training in accordance with aspects described herein.

FIG. 6 is a state diagram for performing DPD training in accordance with aspects described herein.

FIG. 7 is a state diagram for determining severity of a failure in DPD training in accordance with aspects described herein.

FIG. 8 is a block diagram conceptually illustrating an example of a transceiver in accordance with aspects described herein.

FIG. 9 is a block diagram of several sample aspects of apparatuses configured in accordance with aspects described herein.

### DETAILED DESCRIPTION

Described herein are various aspects related to managing digital pre-distortion (DPD) training, which is used to calibrate the transmit power and other radio frequency (RF) front end variables of a transmitter of a device in an operating environment to pre-distort transmitted signals to achieve desired properties. In particular, one or more transmitter components, such as a power amplifier, may have a non-linear input/output behavior, which can cause the output signal to not accurately represent the input signal and also may cause the output signal to interfere with adjacent frequencies. As such, DPD training can inversely model gain and phase characteristics of a power amplifier, and when combined with the input to the power amplifier, can produce a result that is more linear and reduces distortion at the power amplifier.

In a specific example, DPD training can include computing coefficients related to determined distortion in communicating signals over one or more portions of the RF front end (e.g., an in-phase (I) and/or quadrature phase (Q) branch). The RF transceiver can employ the coefficients to pre-distort transmitted or received signals in the digital domain to account for I/Q imbalance by accordingly adjusting digital and analog gain at the RF transceiver of the wireless device to reduce the distortion to a linear system. For example, wireless devices perform DPD training instead of relying on factory provided coefficients for I/Q imbalance calibration that may not be applicable because of ageing or other operational/environmental changes.

For example, however, DPD training may not always succeed, and indeed the DPD training process may include mechanisms for detecting errors (or failures) during the DPD training. In an example, when a certain type of failure is detected, the device can determine whether to perform a self-recovery mechanism (and/or which self-recovery mechanism to perform) in DPD training based on a severity of a failure during the training, a number of repeated failures during the training, and/or the like. For example, for a given failure type, the severity may be determined based on a number of consecutive or statistical failures over a period of time and one or more self-recovery mechanisms may be invoked in an attempt to resolve the failure(s). When the number achieves various thresholds, a next level of severity can be imposed for the failure, which may be associated with continued implementation of the one or more recovery mechanisms, and also with the generation of an alarm or report to notify one or more users of the failure. In a specific example, when a certain level of severity is achieved, the device may reset its transceiver and begin DPD training again.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

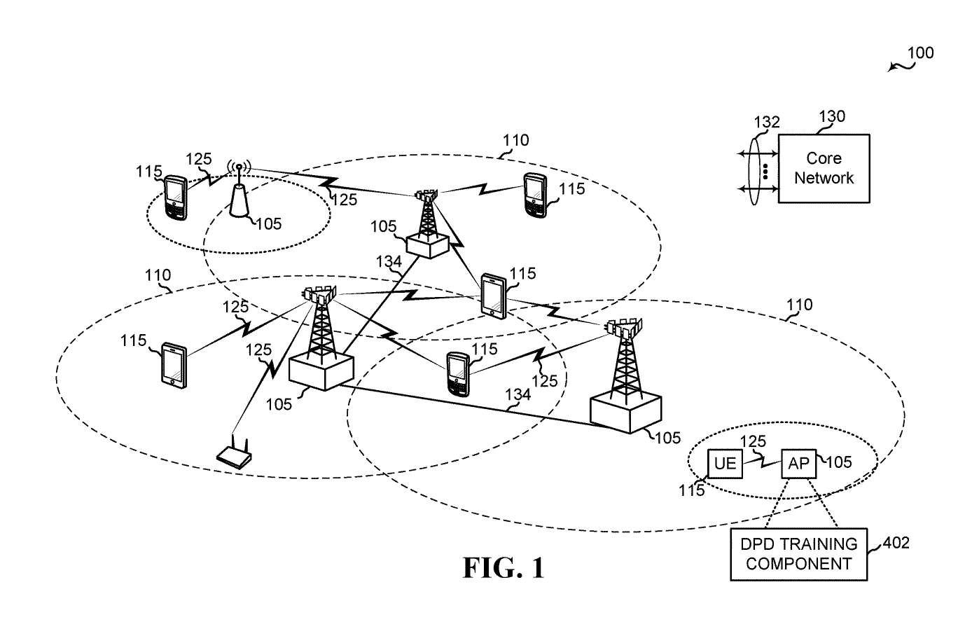

Referring first to FIG. 1, a diagram illustrates an example of a wireless communications system 100, in accordance with aspects described herein. The wireless communications system 100 includes a plurality of access points (e.g., base stations, eNBs, or WLAN access points) 105, a number of user equipment (UEs) 115, and a core network 130. Access points 105 may include a DPD training component 402 for performing DPD training such to computing coefficients related to determined distortion in communicating signals, and pre-distort subsequent communications based on the coefficients.

Some of the access points 105 may communicate with the UEs 115 under the control of a base station controller (not shown), which may be part of the core network 130 or the certain access points 105 (e.g., base stations or eNBs) in various examples. Access points 105 may communicate control information and/or user data with the core network 130 through backhaul links 132. In examples, the access points 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The access points 105 may wirelessly communicate with the UEs 115 via one or more access point antennas. Each of the access points 105 sites may provide communication coverage for a respective coverage area 110. In some examples, access points 105 may be referred to as a base transceiver station, a radio base station, a radio transceiver, a basic service set (BSS), an extended service set (ESS), a NodeB, eNodeB, Home NodeB, a Home eNodeB, or some other suitable terminology. The coverage area 110 for a base station may be divided into sectors making up only a portion of the coverage area (not shown). The wireless communications system 100 may include access points 105 of different types (e.g., macro, micro, femto, and/or pico base stations). The access points 105 may also utilize different radio technologies, such as cellular and/or WLAN radio access technologies (RAT). The access points 105 may be associated with the same or different access networks or operator deployments. The coverage areas of different access points 105, including the coverage areas of the same or different types of access points 105, utilizing the same or different radio technologies, and/or belonging to the same or different access networks, may overlap.

In long term evolution (LTE)/LTE-Advanced (LTE-A) network communication systems, the terms evolved Node B (eNodeB or eNB) may be generally used to describe the access points 105. The wireless communications system 100 may be a Heterogeneous LTE/LTE-A network in which different types of access points provide coverage for various geographical regions. For example, each access point 105 may provide communication coverage for a macro cell, a pico cell, a femto cell, and/or other types of cell. Small cells such as pico cells, femto cells, and/or other types of cells may be provided by small cell base stations as low power nodes or LPNs. A macro cell may generally cover a relatively large geographic area (e.g., several kilometers in radius) and may allow unrestricted access by UEs 115 with service subscriptions with the network provider. In an aspect, as used herein, the term “small cell” may refer to an access point or to a corresponding coverage area of the access point, where the access point in this case has a relatively low transmit power or relatively small coverage as compared to, for example, the transmit power or coverage area of a macro network access point or macro cell. In contrast to a macro cell, a small cell may cover a relatively small geographic area, such as, but not limited to, a home, a building, or a floor of a building. As such, a small cell may include, but is not limited to, an apparatus such as a base station (BS), an access point, a femto node, a femtocell, a pico node, a micro node, a Node B, evolved Node B (eNB), home Node B (HNB) or home evolved Node B (HeNB). Therefore, the term “small cell,” as used herein, refers to a relatively low transmit power and/or a relatively small coverage area cell as compared to a macro cell.

As noted above, a small cell may generally cover a relatively smaller geographic area and may allow unrestricted access by UEs 115 with service subscriptions with the network provider, for example, and in addition to unrestricted access, may also provide restricted access by UEs 115 having an association with the small cell (e.g., UEs in a closed subscriber group (CSG), UEs for users in the home, and the like). An eNB for a macro cell may be referred to as a macro eNB. An eNB for a small cell may be referred to as a small cell eNB. An eNB may support one or multiple (e.g., two, three, four, and the like) cells.

The core network 130 may communicate with the eNBs or other access points 105 via one or more backhaul links 132 (e.g., S1 interface, etc.). The access points 105 may also communicate with one another, e.g., directly or indirectly via backhaul links 134 (e.g., X2 interface, etc.) and/or via backhaul links 132 (e.g., through core network 130). The wireless communications system 100 may support synchronous or asynchronous operation. For synchronous operation, the access points 105 may have similar frame timing, and transmissions from different access points 105 may be approximately aligned in time. For asynchronous operation, the access points 105 may have different frame timing, and transmissions from different access points 105 may not be aligned in time.

The UEs 115 are dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNBs, small cell eNBs, relays, and the like. A UE 115 may also be able to communicate over different access networks, such as cellular or other WWAN access networks, or WLAN access networks.

The communication links 125 shown in wireless communications system 100 may include uplink (UL) transmissions from a UE 115 to an access point 105, and/or downlink (DL) transmissions, from an access point 105 to a UE 115. The downlink transmissions may also be called forward link transmissions while the uplink transmissions may also be called reverse link transmissions. The communication links 125 may carry transmissions of one or more hierarchical layers which, in some examples, may be multiplexed in the communication links 125. The UEs 115 may be configured to collaboratively communicate with multiple access points 105 through, for example, Multiple Input Multiple Output (MIMO), carrier aggregation (CA), Coordinated Multi-Point (CoMP), multiple connectivity (e.g., CA with each of one or more access points 105) or other schemes. MIMO techniques use multiple antennas on the access points 105 and/or multiple antennas on the UEs 115 to transmit multiple data streams. Carrier aggregation may utilize two or more component carriers on a same or different serving cell for data transmission. CoMP may include techniques for coordination of transmission and reception by a number of access points 105 to improve overall transmission quality for UEs 115 as well as increasing network and spectrum utilization.

Each of the different operating modes that may be employed by wireless communications system 100 may operate according to frequency division duplexing (FDD) or time division duplexing (TDD). In some examples, OFDMA communications signals may be used in the communication links 125 for LTE downlink transmissions for each hierarchical layer, while single carrier frequency division multiple access (SC-FDMA) communications signals may be used in the communication links 125 for LTE uplink transmissions.

As described herein, an access point 105 with a DPD training component 402 can manage the DPD training process to handle failures in the process and/or corresponding self-recovery processes, where the failures may include failures related to comparing certain detected parameters relating to the DPD training (e.g., comparing sample power levels, timing offsets, ACLR leakage, etc. to one or more thresholds) to one or more thresholds. For example, DPD training component 402 can detect failure in the DPD training process, and can determine whether to perform self-recovery in an attempt to remediate the failure. For example, DPD training component 402 can determine whether to perform self-recovery and/or a type of self-recovery to perform based at least in part on a severity or type of the failure. In an example, the severity may be determined based on whether the failure is detected in one or more iterations of the DPD training process, based on determining the failure in one or more consecutive iterations or a threshold statistical portion of iterations of the DPD training process. For example, the self-recovery may relate to adjusting an automatic gain control of a feedback receiver to detect DPD training signals, adjusting a K value of the feedback receiver (which can correspond to a number of non-linearity polynomial terms that are incorporated into the DPD model for DPD training), resetting the transceiver, etc.

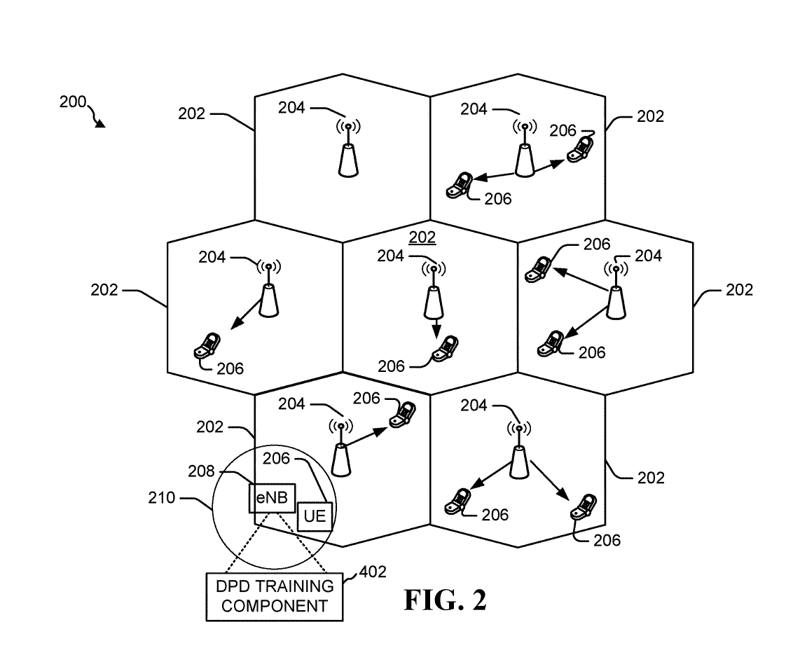

FIG. 2 is a diagram illustrating an example of an access network 200 in an LTE network architecture. In this example, the access network 200 is divided into a number of cellular regions (cells) 202. One or more small cell eNBs 208 (e.g., eNBs of a lower power class than eNBs 204) may have cellular regions 210 that overlap with one or more of the cells 202. The small cell eNB 208 may be a femto cell (e.g., home eNB (HeNB)), pico cell, micro cell, or remote radio head (RRH). The macro eNBs 204 are each assigned to a respective cell 202 and are configured to provide an access point to the core network 130 for all the UEs 206 in the cells 202. One or more of the eNBs 204 or small cell eNBs 208 can include a DPD training component 402 for performing DPD training such to computing coefficients related to determined distortion in communicating signals, and pre-distort subsequent communications based on the coefficients. There is no centralized controller shown in this example of an access network 200, but a centralized controller may be used in alternative configurations. The eNBs 204 are responsible for all radio related functions including radio bearer control, admission control, mobility control, scheduling, security, and connectivity to a serving gateway (not shown).

The modulation and multiple access scheme employed by the access network 200 may vary depending on the particular telecommunications standard being deployed. In LTE applications, OFDM may be used on the DL and SC-FDMA may be used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, Universal Mobile Telecommunications System (UMTS), LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

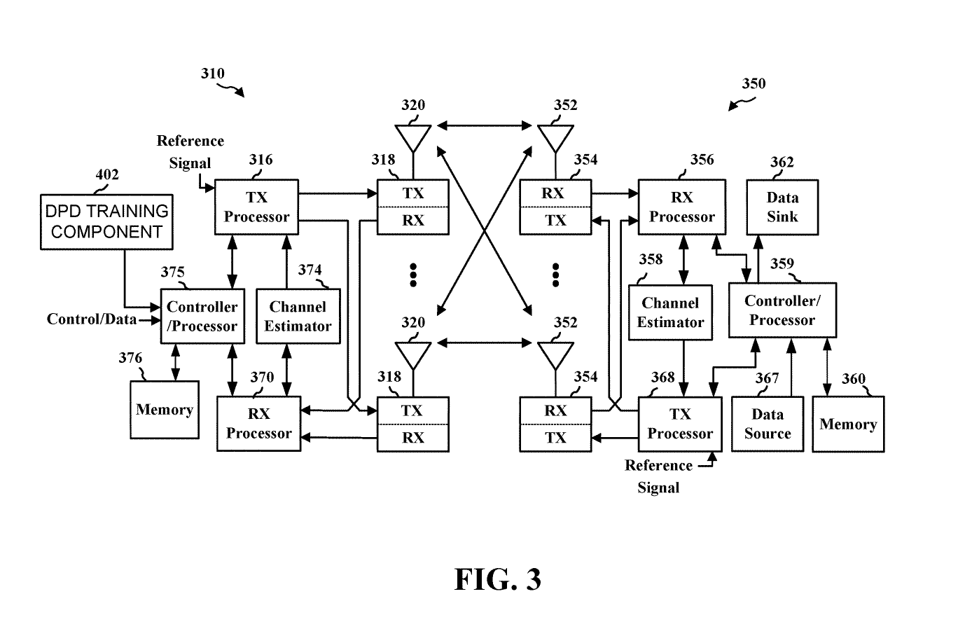

FIG. 3 is a block diagram of an eNB 310 (e.g., access point 105, eNB 204, small cell eNB 208, eNB 440, eNB 450, eNB 460, etc.) in communication with a UE 350 (e.g., UE 115, 206, etc.) in an access network. In the DL, upper layer packets from the core network are provided to a controller/processor 375. The controller/processor 375 implements the functionality of the L2 layer. In the DL, the controller/processor 375 provides header compression, ciphering, packet segmentation and reordering, multiplexing between logical and transport channels, and radio resource allocations to the UE 350 based on various priority metrics. The controller/processor 375 is also responsible for HARQ operations, retransmission of lost packets, and signaling to the UE 350.

The transmit (TX) processor 316 implements various signal processing functions for the L1 layer (i.e., physical layer). The signal processing functions includes coding and interleaving to facilitate forward error correction (FEC) at the UE 350 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream is then provided to a different antenna 320 via a separate transmitter 318TX. Each transmitter 318TX modulates an RF carrier with a respective spatial stream for transmission. In addition, eNB 310 may include a DPD training component 402 for performing DPD training such to computing coefficients related to determined distortion in communicating signals, and pre-distort subsequent communications based on the coefficients. For example, DPD training component 402 can be implemented and/or executed by one or more processors, such as TX processor 316, RX processor 370, controller/processor 375, etc.

At the UE 350, each receiver 354RX receives a signal through its respective antenna 352. Each receiver 354RX recovers information modulated onto an RF carrier and provides the information to the receive (RX) processor 356. The RX processor 356 implements various signal processing functions of the L1 layer. The RX processor 356 performs spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359.

The controller/processor 359 implements the L2 layer. The controller/processor can be associated with a memory 360 that stores program codes and data. The memory 360 may be referred to as a computer-readable medium. In the UL, the controller/processor 359 provides demultiplexing between transport and logical channels, packet reassembly, deciphering, header decompression, control signal processing to recover upper layer packets from the core network. The upper layer packets are then provided to a data sink 362, which represents all the protocol layers above the L2 layer. Various control signals may also be provided to the data sink 362 for L3 processing. The controller/processor 359 is also responsible for error detection using an acknowledgement (ACK) and/or negative acknowledgement (NACK) protocol to support HARQ operations.

In the UL, a data source 367 is used to provide upper layer packets to the controller/processor 359. The data source 367 represents all protocol layers above the L2 layer. Similar to the functionality described in connection with the DL transmission by the eNB 310, the controller/processor 359 implements the L2 layer for the user plane and the control plane by providing header compression, ciphering, packet segmentation and reordering, and multiplexing between logical and transport channels based on radio resource allocations by the eNB 310. The controller/processor 359 is also responsible for HARQ operations, retransmission of lost packets, and signaling to the eNB 310.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 are provided to different antenna 352 via separate transmitters 354TX. Each transmitter 354TX modulates an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370. The RX processor 370 may implement the L1 layer.

The controller/processor 375 implements the L2 layer. The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover upper layer packets from the UE 350. Upper layer packets from the controller/processor 375 may be provided to the core network. The controller/processor 375 is also responsible for error detection using an ACK and/or NACK protocol to support HARQ operations.

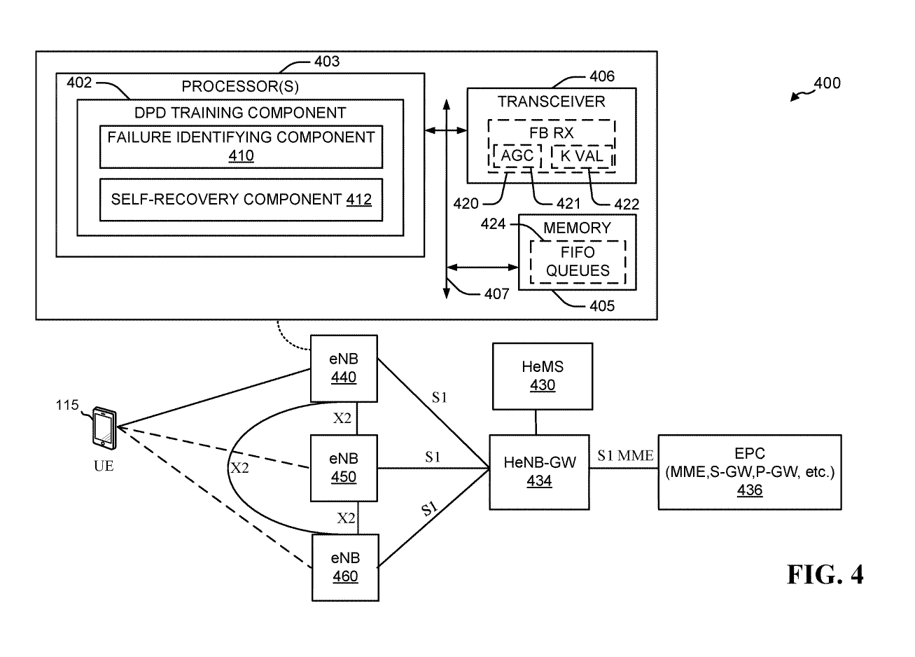

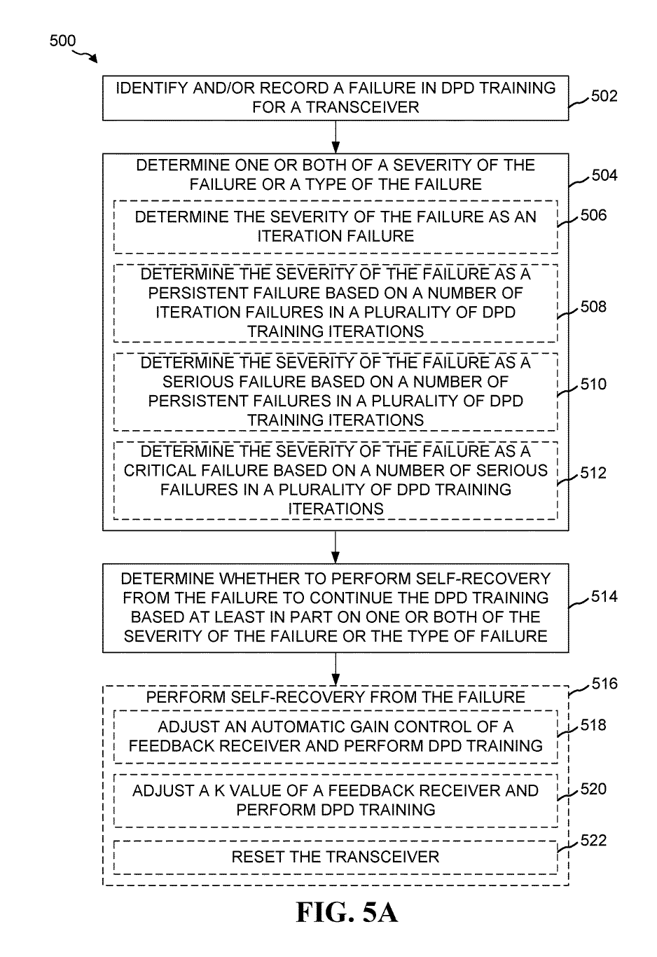

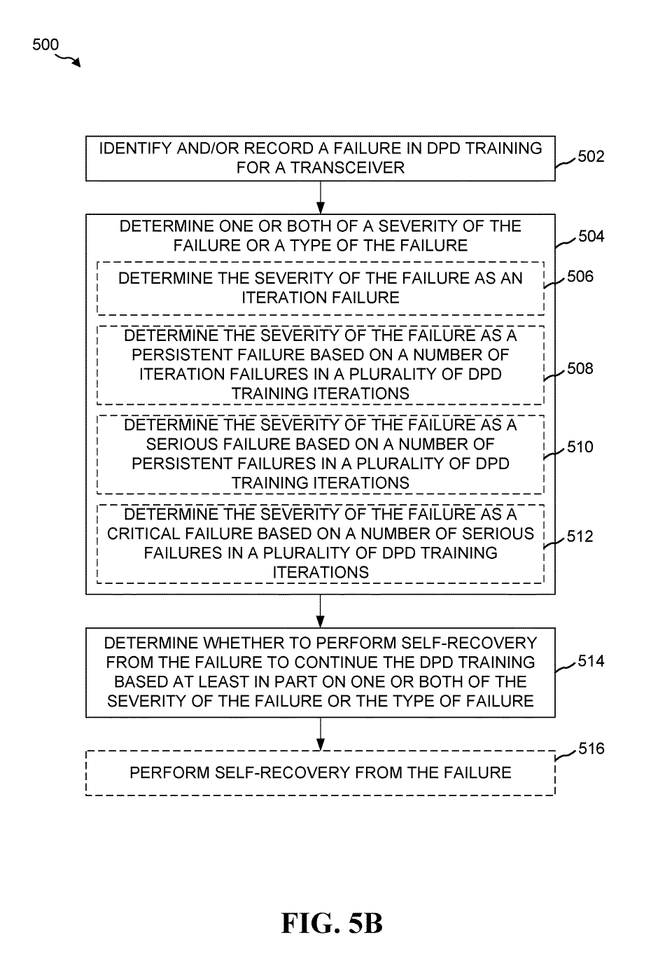

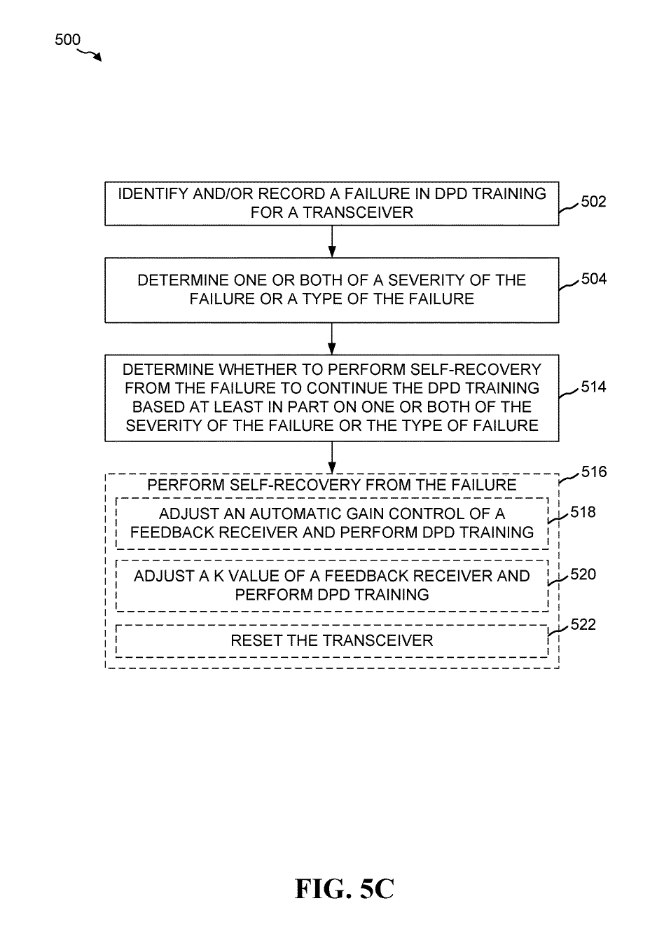

Referring to FIGS. 4-8, aspects are depicted with reference to one or more components and one or more methods that may perform the actions or functions described herein. In an aspect, the term “component” as used herein may be one of the parts that make up a system, may be hardware or software or some combination thereof, and may be divided into other components. Although the operations described below in FIG. 5 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

FIG. 4 is a block diagram conceptually illustrating an example of a network architecture 400, in accordance with aspects described herein. The network architecture 400 may be part of the wireless communications system 100 of FIG. 1, and may include a home eNB management system (HeMS) 430 capable of handling operation, administration, and management (OAM) of small cell base stations in a home network. The network architecture 400 may also include a home eNB gateway (HeNB-GW) 434, an evolved packet core (EPC) 436 (e.g., a core network, such as core network 130), and one or more eNBs 440, 450, 460. The eNBs 440, 450, 460 may be in communication with the HeNB-GW 434 via backhaul interfaces (e.g., an S1 interface). In an additional or an optional aspect, the eNBs 440, 450, 460 may communicate directly with EPC 436 via S1 interface. UE 115 can be in communication with one or more of eNBs 440, 450, 460. Additionally, the eNBs 440, 450, 460 may communicate with one another over backhaul interfaces (e.g., X2 interfaces). The HeNB-GW 434 and the EPC 436 may communicate via an S1 mobility management entity (MME) interface. The eNBs of FIG. 4 may correspond to one or more of the access points/eNBs described above with respect to FIGS. 1-3.

In an aspect, one or more of the eNBs 440, 450, 460 (though shown and described with respect to eNBs 440 only for ease of explanation) may be configured to perform DPD training according to aspects described herein. Accordingly, eNBs 440 may include one or more processors 403 and/or a memory 405 that may be communicatively coupled, e.g., via one or more buses 407, and may operate in conjunction with or otherwise implement DPD training component 402 for performing DPD training such to computing coefficients related to determined distortion in communicating signals, and pre-distort subsequent communications based on the coefficients (e.g., in transceiver 406 or at least a transmitter portion thereof). For example, the various operations related to DPD training component 402 may be implemented or otherwise executed by one or more processors 403 and, in an aspect, can be executed by a single processor, while in other aspects, different ones of the operations may be executed by a combination of two or more different processors. For example, in an aspect, the one or more processors 403 may include any one or any combination of a modem processor, or a baseband processor, or a digital signal processor, or an application specific integrated circuit (ASIC), or a transmit processor, receive processor, or a transceiver processor associated with transceiver 406.

Further, for example, the memory 405 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 403. Moreover, memory 405 or computer-readable storage medium may be resident in the one or more processors 403, external to the one or more processors 403, distributed across multiple entities including the one or more processors 403, etc. Memory 405 may include one or more first-in first-out (FIFO) queues 424 for storing error logs, failure occurrences of one or more severities or types, etc. In addition, transceiver 406 may include one or more RF front end components, such as a transmitter and receiver (and/or related processor(s)), a feedback (FB) receiver (RX) 420 (and/or related processor), etc. FB RX 420 may include one or more components that may be adjusted based on detecting failure (e.g., or success) in DPD training, such as an automatic gain control (AGC) 421, K value 422 (which can correspond to a number of non-linearity polynomial terms that are incorporated into the DPD model for DPD training), etc.

In particular, the one or more processors 403 and/or memory 405 may execute actions or operations defined by DPD training component 402 or its subcomponents. For instance, the one or more processors 403 and/or memory 405 may execute actions or operations defined by a failure identifying component 410 for identifying a failure (or occurrence of a failure) during one or more instances of DPD training. In an aspect, for example, failure identifying component 410 may include hardware (e.g., one or more processor modules of the one or more processors 403) and/or computer-readable code or instructions stored in memory 405 and executable by at least one of the one or more processors 403 to perform the specially configured failure identifying operations described herein. Further, for instance, the one or more processors 403 and/or memory 405 may execute actions or operations defined by a self-recovery component 412 for performing one or more processes in an attempt to self-recover from one or more failures in DPD training. In an aspect, for example, self-recovery component 412 may include hardware (e.g., one or more processor modules of the one or more processors 403) and/or computer-readable code or instructions stored in memory 405 and executable by at least one of the one or more processors 403 to perform the specially configured self-recovery operations described herein.

It is to be appreciated that transceiver 406 may be configured to transmit and receive wireless signals through one or more antennas, an RF front end, one or more transmitters, and one or more receivers. In an aspect, transceiver 406 may be tuned to operate at specified frequencies such that eNB 440 can communicate at a certain frequency. In an aspect, the one or more processors 403 may configure transceiver 406 to operate at a specified frequency and power level based on a configuration, a communication protocol, etc. to communicate uplink signals and/or downlink signals, respectively, over related uplink or downlink communication channels.

In an aspect, transceiver 406 can operate in multiple bands (e.g., using a multiband-multimode modem, not shown) such to process digital data sent and received using transceiver 406. In an aspect, transceiver 406 can be multiband and be configured to support multiple frequency bands for a specific communications protocol. In an aspect, transceiver 406 can be configured to support multiple operating networks and communications protocols. Thus, for example, transceiver 406 may enable transmission and/or reception of signals based on a specified modem configuration.

FIGS. 5A-5C illustrate an example method 500 for managing performing of DPD training (e.g., by an eNB or other device), where optional blocks are denoted by dotted lines. As described, DPD training component 402 can perform DPD training to calibrate transceiver 406 for communicating in an environment. For example, eNB 440 may be installed at an operating location, and DPD training component 402 can transmit one or more signals via transceiver 406, and may measure the signals to calibrate one or more RF front end components of transceiver 406 such to pre-distort signals in subsequent communications. For example, DPD training component 402 may receive the transmitted signals via a FB RX 420, and may compute one or more coefficients that may be subsequently applied on an I-branch and/or Q-branch of the transceiver 406 to pre-distort the subsequent communications to mitigate I/Q imbalance. This can benefit the receiver of the communications (e.g., UE 115). The I/Q imbalance may be caused by various environmental factors, such as obstacles, temperature, humidity, etc., and thus performing the DPD training can assist in calibrating the transceiver 406 to improve communications in its operating environment. In an example, DPD training component 402 can periodically perform the DPD training 402 to update the coefficients as conditions change over time. As described further herein, however, DPD training may not always succeed due to various factors of the various components involved.

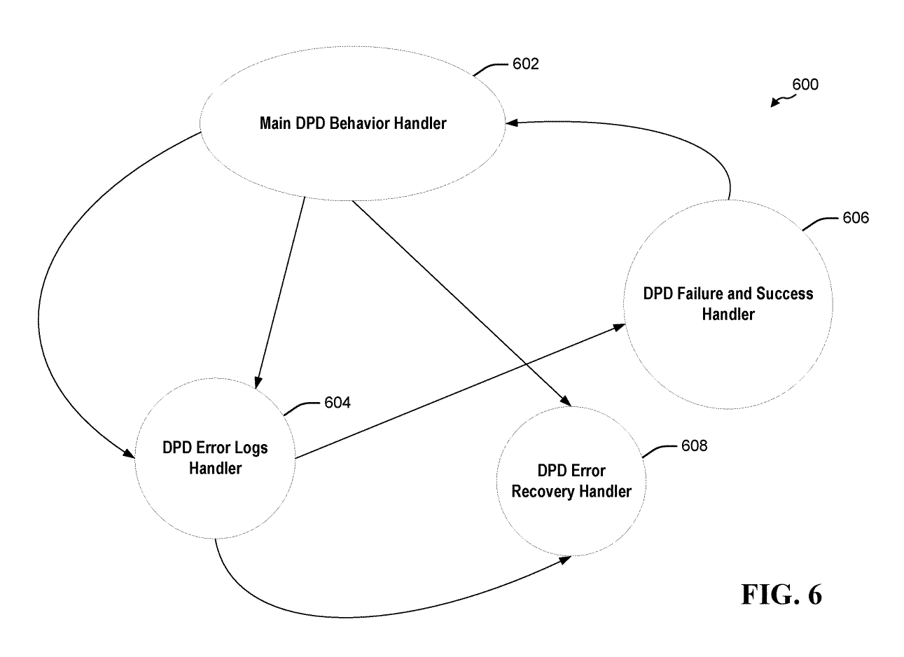

FIG. 6 illustrates a diagram of a specific example of a DPD training states 600. A main DPD behavior handler state 602 is shown for performing iterations and re-iterations of DPD training (e.g. by DPD training component 402), deciding whether to act on a reported DPD failure severity and/or DPD success, raising/clearing alarms related to DPD failures, invoking recovery, manage, or other modules of the DPD training component 402, etc., as described further herein.

Referring to FIGS. 5A-5C, method 500 includes, at Block 502, identifying or recording a failure in DPD training for a transceiver. In an aspect, failure identifying component 410, e.g., in conjunction with the processor(s) 403, memory 405, and/or transceiver 406, may identify or record the failure in DPD training for the transceiver 406. For example, failure identifying component 410 may identify the failure based on one or more event handlers in the DPD training process performed by DPD training component 402 for detecting the failure, based on monitoring one or more error logs generated during the DPD training process, based on monitoring the contents of one or more FIFO queues 424 that can store information regarding one or more detected failure events in the DPD process, and/or the like. In another example, failure identifying component 410 may record data regarding the failures in the one or more error logs, contents of FIFO queues 424, etc.

In the specific example in FIG. 6, where failures occur during the DPD training, DPD training component 402 can transition from main DPD behavior handler state 602 to a DPD error logs handler state 604 to update a given iteration with success/failure status and/or report quantitative values of error types (e.g., adjacent channel leakage ratio (ACLR) values). In DPD error logs handler state 604, iteration success/failure results for error types can be recorded, counters can be updated, etc. for each iteration of DPD training. For example, DPD training component 402 can record iteration success/failure results for one or more DPD iterations on one or more of the FIFO queues 424 in memory 405. In a specific example, FIFO queues 424 may include a success/failure FIFO and/or a failure value FIFO for each of a plurality of failure or error types, as described further herein, where failure identifying component 410 can input a 0 into a success/failure FIFO where a failure is not detected, and a 1 where an error of the specific failure type corresponding to the FIFO is detected. Similarly, for example, failure identifying component 410 can input a numeric value correspond into a failure value FIFO indicating a numeric value of the detected failure in the corresponding failure value FIFO (e.g., a detected ACLR, a feedback signal level, etc.).

Referring to FIGS. 5A-5C, method 500 may also include, at Block 504, determining one or both of a severity of the failure or a type of the failure. In an aspect, failure identifying component 410, e.g., in conjunction with processor(s) 403, memory 405, and/or transceiver 406, may determine one of both of the severity of the failure or the type of the failure. In an example, failure identifying component 410 may determine a type of the failure based on receiving relevant information from an error handler during the DPD training process, monitoring error logs or related FIFO queues 424, etc., as described above. For example, a type of failure may correspond to one or more parameters based on which the failure is determined (e.g., based on comparing one or more parameters, such as a sample power, offset, ACLR leakage, etc. to one or more thresholds). In another example, failure identifying component 410 may determine the severity of the failure based on whether the failure is occurring over one or more iterations of DPD training. In one example, failure identifying component 410 may determine the severity of a failure based on how often or how many times a failure is detected over a set number of DPD training iterations, where the larger the number of occurrences the more severe a failure can be considered. In an example, the severity of the failure may relate to whether the failure is detected at an iteration, persistent across multiple iterations, serious (e.g., as being considered persistent across multiple iterations), critical (e.g., as being considered serious across multiple iterations), etc.

In an example, referring to FIG. 5B, determining one or both of the severity of the failure or the type of the failure, at Block 504, may also optionally include, at Block 506, determining the severity of the failure as an iteration failure. In an aspect, failure identifying component 410, e.g., in conjunction with processor(s) 403, memory 405, and/or transceiver 406, may determine the severity of the failure as an iteration failure. For example, failure identifying component 410 can input a 0 to a DPD iteration success/failure FIFO in FIFO queues 424 where a DPD iteration succeeds without failure, or a 1 into the DPD iteration success/failure FIFO where the DPD iteration fails (e.g., where failure identifying component 410 may also put a 1 in a corresponding success/failure FIFO or failure value FIFO for a given failure type, as described above). For example, failure identifying component 410 may input the 1 to the DPD iteration success/failure FIFO where failure identifying component 410 identifies at least one type of failure in an iteration of the DPD process performed by DPD training component 402.

In another example, determining one or both of the severity of the failure or the type of the failure, at Block 504, may also optionally include, at Block 508, determining the severity of the failure as a persistent failure based on a number of iteration failures in a plurality of DPD training iterations. In an aspect, failure identifying component 410, e.g., in conjunction with processor(s) 403, memory 405, and/or transceiver 406, may determine the severity of the failure as a persistent failure based on a number of iteration failures in a plurality of DPD training iterations. For example, failure identifying component 410 can input a 0 to a DPD persistent success/failure FIFO in FIFO queues 424 where a DPD failure is deemed not to be persistent, or a 1 into the DPD persistent success/failure FIFO where the DPD failure is deemed persistent. In a specific example, failure identifying component 410 may determine whether a failure is persistent based at least in part on determining whether a number of a specific type of failures has occurred in consecutive DPD iterations and/or whether a number of the specific type of failures has occurred in a statistical threshold (e.g., a percentage) of previous DPD iterations. For example, failure identifying component 410 may determine whether the number of specific types of failures have occurred based at least in part on determining whether the success/failure FIFO, for the given failure type, in the FIFO queues 424 has a consecutive number of 1's that achieve a threshold, and/or whether the success/failure FIFO for the given failure type has a statistical threshold (e.g., a percentage) of 1's over a number of previous DPD training iterations. In an example, failure identifying component 410 may utilize a different threshold per failure type for the persistent failure determination to set a lower or higher tolerance level of the failure type. In another example, failure identifying component 410 may determine whether the number of iteration failures generally have occurred based at least in part on determining whether the DPD iteration success/failure FIFO has a consecutive number of 1's that achieve a threshold, and/or whether the DPD iteration success/failure FIFO has a statistical threshold (e.g., a percentage) of 1's over a number of previous DPD training iterations. In either case, where failure identifying component 410 determines a persistent failure, failure identifying component 410 can input a 1 into the DPD persistent success/failure FIFO, or a 0 otherwise.

In another example, determining one or both of the severity of the failure or the type of the failure, at Block 504, may also optionally include, at Block 510, determining the severity of the failure as a serious failure based on a number of persistent failures in a plurality of DPD training iterations. In an aspect, failure identifying component 410, e.g., in conjunction with processor(s) 403, memory 405, and/or transceiver 406, may determine the severity of the failure as a serious failure based on a number of persistent failures in a plurality of DPD training iterations. For example, failure identifying component 410 can input a 0 to a DPD serious success/failure FIFO in FIFO queues 424 where a DPD failure is deemed not to be serious, or a 1 into the DPD persistent success/failure FIFO where the DPD failure is deemed serious. In a specific example, failure identifying component 410 may determine whether a failure is serious based at least in part on determining a failure value (e.g., in a failure value FIFO for a failure type) relative to a threshold value (e.g., determining whether an ACLR value for an ACLR failure achieves a threshold ACLR value). In another specific example, failure identifying component 410 may determine whether a failure is serious based at least in part on determining whether a number of a specific type of failures has occurred in consecutive DPD iterations and/or whether a number of the specific type of failures has occurred in a statistical threshold (e.g., a percentage) of previous DPD iterations. For example, failure identifying component 410 may determine whether the number of specific types of failures have occurred based at least in part on determining whether the success/failure FIFO, for the given failure type, in the FIFO queues 424 has a consecutive number of 1's that achieve a threshold, and/or whether the success/failure FIFO for the given failure type has a statistical threshold (e.g., a percentage) of 1's over a number of previous DPD training iterations. In an example, failure identifying component 410 may utilize a different threshold per failure type for the serious failure determination to set a lower or higher tolerance level of the failure type. In another example, failure identifying component 410 may determine whether the number of persistent failures generally have occurred based at least in part on determining whether the DPD persistent success/failure FIFO has a consecutive number of 1's that achieve a threshold, and/or whether the DPD persistent success/failure FIFO has a statistical threshold (e.g., a percentage) of 1's over a number of previous DPD training iterations. In either case, where failure identifying component 410 determines a serious failure, failure identifying component 410 can input a 1 into the DPD serious success/failure FIFO, or a 0 otherwise

In another example, determining one or both of the severity of the failure or the type of the failure, at Block 504, may also optionally include, at Block 512, determining the severity of the failure as a critical failure based on a number of serious failures in a plurality of DPD training iterations. In an aspect, failure identifying component 410, e.g., in conjunction with processor(s) 403, memory 405, and/or transceiver 406, may determine the severity of the failure as a critical failure based on a number of serious failures in a plurality of DPD training iterations. For example, failure identifying component 410 can take action to recover from the critical failure, as described further herein. In a specific example, failure identifying component 410 may determine whether a failure is critical based at least in part on determining a failure value (e.g., in a failure value FIFO for a failure type) relative to a threshold value (e.g., determining whether an ACLR value for an ACLR failure achieves a threshold ACLR value). For example, failure identifying component 410 may use different threshold values for different severities (e.g., a first threshold value to indicate a serious failure and another to indicate a critical failure). In another specific example, failure identifying component 410 may determine whether a failure is critical based at least in part on determining whether a number of a specific type of failures has occurred in consecutive DPD iterations and/or whether a number of the specific type of failures has occurred in a statistical threshold (e.g., a percentage) of previous DPD iterations. For example, failure identifying component 410 may determine whether the number of specific types of failures have occurred based at least in part on determining whether the success/failure FIFO, for the given failure type, in the FIFO queues 424 has a consecutive number of 1's that achieve a threshold, and/or whether the success/failure FIFO for the given failure type has a statistical threshold (e.g., a percentage) of 1's over a number of previous DPD training iterations. In an example, failure identifying component 410 may utilize a different threshold per failure type for the critical failure determination to set a lower or higher tolerance level of the failure type. In another example, failure identifying component 410 may determine whether the number of serious failures generally have occurred based at least in part on determining whether the DPD serious success/failure FIFO has a consecutive number of 1's that achieve a threshold, and/or whether the DPD serious success/failure FIFO has a statistical threshold (e.g., a percentage) of 1's over a number of previous DPD training iterations.

In an example, where failure identifying component 410 does not detect a failure in a DPD training iteration, failure identifying component 410 can clear one or more of the FIFO queues. Thus, in referring to FIG. 6, DPD training component 402 can transition from state 602 to DPD error logs handler state 604 where overall DPD success is declared to clear error logs for all error types. Below is a list of example detectable DPD training failure types (e.g., where FIFO queues 424 may include a FIFO queue for success/failure of each of the failure types and/or a FIFO queue for related failure values):

| DPD Training failure types | Failure description | Possible Reason for failure |
|---|---|---|
| TRAIN_DATA_FAIL_1 | Threshold for minimal TX | Training is being done with |
| | samples (power amplifier | de-boosted Tx power or not |
| | input (pa_in)) average power | full allocation of Tx data |
| | unreached - signal level is too low | resources |
| TRAIN_DATA_FAIL_2 | Threshold for feedback | Feedback gain state is not |
| | samples average power | well adjusted vs. Tx gain |
| | unreached - feedback signal | state |
| | level is too low | |
| TRAIN_DATA_FAIL_3 | Threshold for feedback vs. Tx | 1. Feedback configuration |
| | timing offset exceeded | might be wrong. |
| | | 2. The spectrum is inverted. |
| TRAIN_DATA_FAIL_4 | Threshold for feedback vs. Tx | 1. Feedback configuration |
| | normalized peak of cross | might be wrong |
| | correlation is too low | 2. The spectrum is inverted. |
| TRAIN_DATA_FAIL_5 | Threshold for ACLR | |
| | exceeded | |
| TRAIN_DATA_FAIL_6 | DPD internal sealer shifter for | Non linearity order of the |
| | preventing clipping based on | model is too high |
| | signal level/characteristics | |
| | exceeded. | |
| TRAIN_DATA_FAIL_7 | Threshold for feedback | Feedback gain state is not |
| | samples average power | well adjusted vs. Tx gain |
| | exceeded - feedback signal | state |
| | level is too high | |
| TRAIN_DATA_FAIL_8 | Threshold for minimal | Orthogonal Channel Noise |
| | average peak of Tx data was | Simulator (OCNS)/signal |
| | unreached | do not contains high peaks |
| TRAIN_DATA_FAIL_9 | Threshold for maximal Tx | OCNS/signal power is too |
| | samples average power | high |
| | exceeded | |

Referring again to FIG. 6, where failure identifying component 410 identifies one or more failures, DPD training component 402 can transition from DPD error logs handler state 604 to DPD failure and success handler state 606 to evaluate and/or declare or clear overall DPD failure severity or success based on received error logs, and/or to a DPD error recovery handler state 608 to carry out error recovery mechanisms for one or more error (failure) types based on the error logs, as described further herein. As described, the error logs may include one or more of the FIFO queues 424 as modified by DPD training component 402 during one or more iterations of the DPD training process. In an example, DPD training component 402 can transition from DPD failure and success handler state 606 to the main DPD behavior handler state 602 by reporting DPD failure and/or success status (e.g., for determining whether to transition to the DPD error recovery handler state 608, as described further below).

Referring to FIGS. 5A-5C, in an example, method 500 may also include, at Block 514, determining whether to perform self-recovery from the failure to continue the DPD training based at least in part on one or both of the severity of the failure or the type of the failure. In an aspect, self-recovery component 412, e.g., in conjunction with the processor(s) 403, memory 405, and/or transceiver 406, may determine whether to perform self-recovery from the failure to continue the DPD training based at least in part on one or both of the severity of the failure or the type of the failure. In an example, self-recovery component 412 can determine a type of self-recovery to perform based on the failure type and/or the severity of the failure. For example, self-recovery component 412 may determine to set an alarm indicating the severity and/or type of failure, adjust a AGC 421 of the FB RX 420, a K value 422 of the FB RX 420, etc., may determine to reset the transceiver 406, and/or substantially any remediation processes based on detecting failures of a certain type, severity, etc.

In an example, method 500 may optionally include, at Block 516, performing self-recovery from the failure. In an aspect, self-recovery component 412, e.g., in conjunction with the processor(s) 403, memory 405, and/or transceiver 406, may perform the self-recovery from the failure. For example, this may be based at least in part on determining to perform self-recovery at Block 514. Moreover, for example, self-recovery component 412 may determine a type of self-recovery to perform based at least in part on the severity of the failure and/or the type of the failure. In an example, performing the self-recovery may include performing another instance of DPD training by DPD training component 402. This may be the self-recovery mechanism where failure identifying component 410 identifies a TRAIN_DATA_FAIL_1, TRAIN_DATA_FAIL_3, TRAIN_DATA_FAIL_4, TRAIN_DATA_FAIL_8, or TRAIN_DATA_FAIL_9 from the table above. In another example, performing the self-recovery may include performing self-recovery as defined for another failure, such as ACLR (e.g., where failure identifying component 410 identifies a TRAIN_DATA_FAIL_5 from the table above). In another example, performing the self-recovery may additionally or alternatively include reporting the failure (e.g., the type of failure and/or severity of the failure) to an interface, a core network component, etc., to facilitate notification of the failure and/or initiation of a recovery mechanism via an interface to the eNB 440.

In another specific example in FIG. 6, where failures occur during the DPD training, DPD training component 402 can transition from main DPD behavior handler state 602 to a DPD error recovery handler state 608 to invoke, stop/suspend, and/or provide related information for error recovery mechanisms for one or more error (failure) types (which may be based on the severity of the error type(s)).

For example, referring to FIG. 5C, performing self-recovery may also optionally include, at Block 518, adjusting an automatic gain control of a feedback receiver and performing DPD training. In an aspect, self-recovery component 412, e.g., in conjunction with the processor(s) 403, memory 405, and/or transceiver 406, may adjust the automatic gain control of the FB RX 420 and cause DPD training component 402 to perform another instance of DPD training. In an example, self-recovery component 412 can decrease the gain of the AGC 421 by one increment (e.g., 1 decibel (dB)) from a current gain based on failure identifying component 410 detecting a TRAIN_DATA_FAIL_2 or TRAIN_DATA_FAIL_7 from the table above. In this example, self-recovery component 412 can continue to decrement the gain for each failed DPD training iteration, but may set a maximum total decrement (and/or a minimum gain value) below a gain level specified in calibration data for the transmitter output power level. In another example, self-recovery component 412 can increment the gain after one or more successful DPD training iterations and/or where the failure type passes without failure a number of times (e.g., in consecutive iterations of DPD training).

In another example, performing self-recovery may also optionally include, at Block 520, adjusting a K value of a feedback receiver and performing DPD training. In an aspect, self-recovery component 412, e.g., in conjunction with the processor(s) 403, memory 405, and/or transceiver 406, may adjust the K value of the FB RX 420 and cause DPD training component 402 to perform another instance of DPD training. As described, the K value can correspond to an internal scaler shifter for preventing clipping based on signal level/characteristics exceeded during DPD training, which may occur when the non-linearity order of the DPD training model is too high (e.g., above a threshold). In an example, self-recovery component 412 can decrease the K value 422 by one increment from a current value gain based on failure identifying component 410 detecting a TRAIN_DATA_FAIL_6 from the table above. In this example, self-recovery component 412 can continue to decrement the K value 422 for each failed DPD training iteration, but may set a maximum total decrement beyond which the K value cannot be decremented. In addition, in an example, if DPD training succeeds in a current iteration (e.g., based on decrementing the K value 422) or if the failure type has passed without failure a number of times (e.g., in consecutive iterations of DPD training), the K value can be incremented by 1.

In another example, performing self-recovery may also optionally include, at Block 522, resetting the transceiver. In an aspect, self-recovery component 412, e.g., in conjunction with the processor(s) 403, memory 405, and/or transceiver 406, may reset the transceiver 406. In an example, self-recovery component 412 can reset the transceiver 406 where failure identifying component 410 determines the severity of the failure to be critical, as described. In an example, when the transceiver 406 becomes active after reset, DPD training component 402 may again initialize a DPD training process for the transceiver 406.

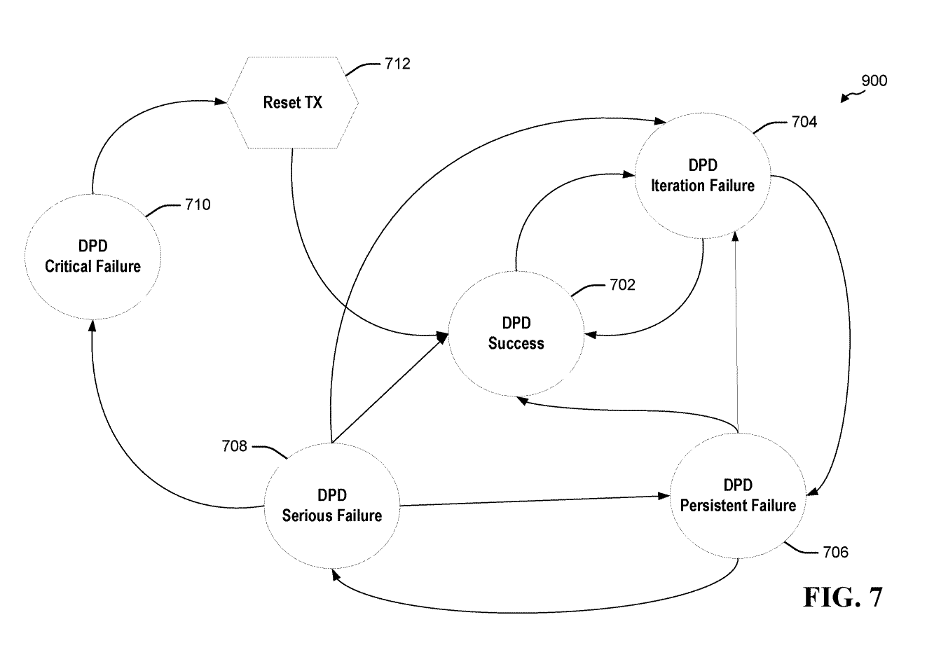

In any case, self-recovery component 412 may perform self-recovery based on a type of a given failure and/or severity of one or more failures. For example, for persistent DPD failures, self-recovery component 412 may invoke self-recovery mechanisms for the failure type (as described), and/or may clear a persistent DPD failure status if no longer valid. In another example, for serious DPD failures, self-recovery component 412 may invoke self-recovery mechanisms for the failure type (as described), may trigger an alarm until the serious failure is not valid, and/or may clear a persistent DPD failure status if no longer valid. For example, self-recovery component 412 may trigger the alarm on an interface (e.g., of the eNB 440 and/or a remotely located core network component), which may allow for performing one or more actions on the eNB 440, such as resetting the transceiver 406, resetting the eNB 440, adjusting one or more values of the transceiver 406 (e.g., AGC, 421, K value 422, etc.), and/or the like. For example, for critical DPD failures, self-recovery component 412 may reset the transceiver 406 and/or may trigger an alarm on the interface, as described. An example of transitioning between failure states is shown in FIG. 7.

FIG. 7 illustrates example states 700 of DPD training. For example, states 700 includes a DPD success state 702, during which DPD training component 402 may set a DPD success status indicator to 1. Where failure identifying component 410 identifies a DPD iteration failure in the DPD training iteration, as described above, DPD training component 402 can transition to a DPD iteration failure state 704 where a DPD iteration failure status indicator is set to 1. Where failure identifying component 410 does not identify the DPD iteration failure in a subsequent DPD training iteration, DPD training component 402 can transition back to DPD success state 702, with a DPD success indicator set to 1. Where the DPD iteration failure persists for a number of consecutive DPD iterations or a percentage of DPD iterations, as described, the DPD training component 402 may transition to a DPD persistent failure state 706 where a DPD persistent failure status indicator is set to 1. Where failure identifying component 410 does not identify the DPD persistent failure in one or more subsequent DPD training iterations, DPD training component 402 may transition to DPD success state 702, with a DPD success indicator set to 1, or to DPD iteration failure state 704 (e.g., where the failure is detected, but not in the percentage defined for a DPD persistent failure), with DPD iteration failure status indicator set to 1 and DPD persistent failure status indicator set to 0. Where the DPD persistent failure persists for a number of consecutive DPD iterations or a percentage of DPD iterations, as described, the DPD training component 402 may transition to a DPD serious failure state 708 where a DPD serious failure status indicator is set to 1, and an alarm can be triggered. Where failure identifying component 410 does not identify the DPD serious failure in one or more subsequent DPD training iterations, DPD training component 402 may transition to DPD success state 702, with a DPD success indicator set to 1, to DPD persistent failure state 706 (e.g., where the failure is detected, but not in the percentage defined for a DPD serious failure), with DPD persistent failure status indicator set to 1 and DPD serious failure status indicator set to 0, or to DPD iteration failure state 704 (e.g., where the failure is detected, but not in the percentage defined for a DPD serious failure or a DPD persistent failure), with DPD iteration failure status indicator set to 1, DPD persistent failure status indicator set to 0, and DPD serious failure status indicator set to 0. Where the DPD serious failure persists for a number of consecutive DPD iterations or a percentage of DPD iterations, as described, the DPD training component 402 may transition to a DPD critical failure state 710 where a DPD critical failure status indicator is set to 1, and an alarm can be triggered. Subsequently, DPD training component 402 may reset the transceiver 406 at state 712, and return to the DPD success state 702 (e.g., when the transceiver has re-started).

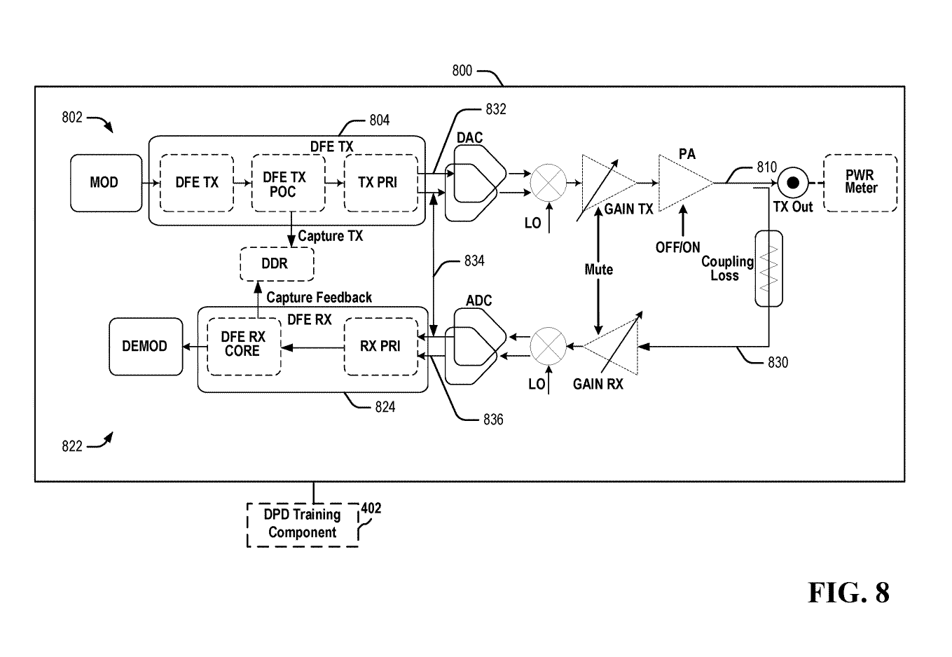

FIG. 8 illustrates an example transceiver 800 in accordance with aspects described herein. For example, transceiver 406 may include one or more components of transceiver 800. Transceiver 800 includes a transmitter branch 802 with various transmitter components (which may include one or more digital front end (DFE) transmitter (TX) components 804), and a receiver branch 822 with various receiver components (which may include one or more digital front end (DFE) receiver (RX) components 824). Transmitter branch 802 may be used to transmit a signal 810, which can be received (e.g., with some coupling loss) as signal 830 fed back into the receiver branch 822. In accordance with aspects described herein, a DPD training component 402 (and/or components thereof, as described herein) can optionally be coupled to transceiver 800 for performing DPD training iterations and/or adjusting one or more components of the transceiver 800 based on the DPD training and/or to self-recover from a failure during a DPD training iteration, as described herein.

In a specific example, DPD training component 402 can perform DPD training iterations to calibrate the transceiver 800, as described herein. In an example, DPD training component 402 (e.g., via failure identifying component 410) can attempt to identify a TRAIN_DATA_FAIL_1 at the output 832 of the DFE TX 804. For example, DPD training component 402 may determine that a minimal threshold for transmitter samples (e.g., power amplifier input) average power is not reached at the output 832 of DFE TX 804, and may declare the TRAIN_DATA_FAIL_1 failure type. DPD training component 402 may additionally report the failure, add data to a corresponding FIFO, determine whether to perform self-recovery, etc., as described above, based on declaring the TRAIN_DATA_FAIL_1.

In another example, DPD training component 402 (e.g., via failure identifying component 410) can attempt to identify a TRAIN_DATA_FAIL_2 or a TRAIN_DATA_FAIL_7 at the input 836 to the DFE RX 824. For example, DPD training component 402 may determine that a threshold for feedback samples average power is not reached or exceeds a threshold at the input 836 to DFE RX 824, and may declare the TRAIN_DATA_FAIL_2 or TRAIN_DATA_FAIL_7 type, respectively. DPD training component 402 may additionally report the failure, add data to a corresponding FIFO, determine whether to perform self-recovery, etc., as described above, based on declaring the TRAIN_DATA_FAIL_2 or TRAIN_DATA_FAIL_7.

In another example, DPD training component 402 (e.g., via failure identifying component 410) can attempt to identify a TRAIN_DATA_FAIL_3 or a TRAIN_DATA_FAIL_4 based on a correlation 834 of the output 832 of DFE TX 804 and the input 836 to the DFE RX 824. For example, DPD training component 402 may determine that offset of the correlation 834 (e.g., of feedback samples versus transmitter samples) timing offset exceeds a threshold, or that cross-correlation between the feedback samples and the transmitted samples to fails achieve a threshold, and may declare the TRAIN_DATA_FAIL_3 or TRAIN_DATA_FAIL_4 type, respectively. DPD training component 402 may additionally report the failure, add data to a corresponding FIFO, determine whether to perform self-recovery, etc., as described above, based on declaring the TRAIN_DATA_FAIL_3 or TRAIN_DATA_FAIL_4.

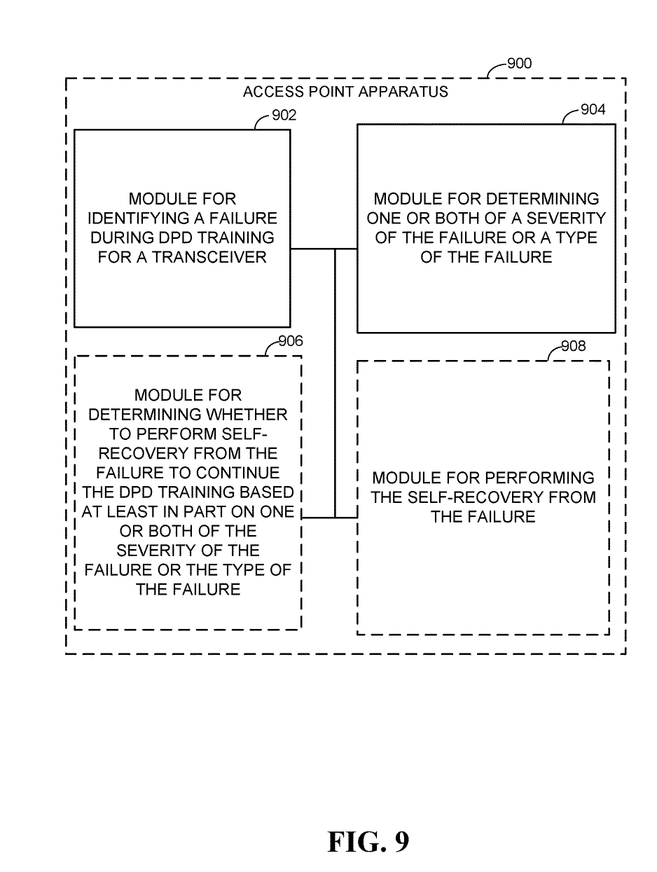

FIG. 9 illustrates an example access point apparatus 900 represented as a series of interrelated functional modules. A module for identifying a failure during DPD training for a transceiver 902 may correspond at least in some aspects to, for example, a processing system or communication device (e.g., a receiver, transceiver, etc.), as discussed herein. A module for determining one or both of a severity of the failure or a type of the failure 904 may correspond at least in some aspects to, for example, a processing system or communication device (e.g., a receiver, transceiver, etc.), as discussed herein. A module for determining whether to perform self-recovery from the failure to continue the DPD training based at least in part on one or both of the severity of the failure or the type of the failure 906 may correspond at least in some aspects to, for example, a processing system or communication device (e.g., a receiver, transceiver, etc.), as discussed herein. A module for performing the self-recovery from the failure 908 (e.g., where the module 906 determines to perform the self-recovery) may correspond at least in some aspects to, for example, a processing system or communication device (e.g., a receiver, transceiver, etc.), as discussed herein.

The functionality of the modules of FIG. 9 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module.

In addition, the components and functions represented by FIG. 9 as well as other components and functions described herein, may be implemented using any suitable means. Such means also may be implemented, at least in part, using corresponding structure as taught herein. For example, the components described above in conjunction with the “module for” components of FIG. 9 also may correspond to similarly designated “means for” functionality. Thus, in some aspects one or more of such means may be implemented using one or more of processor components, integrated circuits, or other suitable structure as taught herein.

It is understood that the specific order or hierarchy of steps in the processes disclosed is an illustration of example approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for resolving failures in digital pre-distortion (DPD) training in wireless communications, comprising:
identifying a failure during DPD training for a transceiver;
determining one or both of a severity of the failure or a type of the failure;
performing self-recovery from the failure to continue the DPD training based at least in part on one or both of the severity of the failure or the type of the failure.

2. The method of claim 1, wherein determining the severity of the failure comprises determining the severity as one of an iteration failure during an iteration of the DPD training or a persistent failure in a plurality of DPD training iterations.

3. The method of claim 2, wherein determining the severity of the failure as the persistent failure comprises detecting a plurality of consecutive iteration failures over the plurality of DPD training iterations.

4. The method of claim 2, wherein determining the severity of the failure as the persistent failure comprises detecting that a plurality of iteration failures over the plurality of DPD training iterations achieves a statistical threshold.

5. The method of claim 2, wherein determining the severity of the failure further comprises determining the severity as a serious failure based at least in part on detecting a plurality of persistent failures over the plurality of DPD training iterations.

6. The method of claim 5, wherein determining the severity as the serious failure is based at least in part on detecting the plurality of persistent failures as a plurality of consecutive persistent failures over the plurality of DPD training iterations.

7. The method of claim 5, wherein determining the severity as the serious failure is based at least in part on detecting the plurality of persistent failures over the plurality of DPD training iterations as achieving a statistical threshold.

8. The method of claim 5, further comprising signaling an alarm to indicate the severity of the failure as the serious failure.

9. The method of claim 5, wherein determining the severity of the failure further comprises determining the severity as a critical failure based at least in part on detecting a plurality of serious failures over the plurality of DPD training iterations.

10. The method of claim 9, wherein determining the severity as the critical failure is based at least in part on detecting the plurality of serious failures as a plurality of consecutive serious failures over the plurality of DPD training iterations.

11. The method of claim 9, wherein determining the severity as the critical failure is based at least in part on detecting the plurality of serious failures over the plurality of DPD training iterations as achieving a statistical threshold.

12. The method of claim 9, further comprising resetting the transceiver based at least in part on detecting the severity as the critical failure.

13. The method of claim 1, wherein determining whether to perform the self-recovery comprises determining a type of self-recovery to perform based at least in part on the severity of the failure.

14. The method of claim 13, wherein the type of self-recovery includes increasing or decreasing an automatic gain control of a feedback receiver in the transceiver used during DPD training, and performing another iteration of DPD training.

15. The method of claim 13, wherein the type of self-recovery includes increasing or decreasing a K value of a feedback receiver in the transceiver used during DPD training, and performing another iteration of DPD training.

16. The method of claim 1, wherein the type of the failure includes at least one of adjacent channel leakage ratio (ACLR) from the transceiver achieving a threshold, failure of transmitter samples of the transceiver to achieve a minimal average power threshold, offset of feedback samples versus transmitter timing offset of the transceiver achieving a threshold, failure of power of feedback samples versus transmitter normalized peak of cross correlation of the transceiver to achieve a threshold, failure of average peak of transmitter data of the transceiver to achieve a minimal threshold, transmitter samples average power of the transceiver achieving a threshold, or a combination thereof.

17. An apparatus for resolving failures in digital pre-distortion (DPD) training in wireless communications, comprising:
a radio frequency (RF) transceiver;
at least one processor communicatively coupled with the RF transceiver via a bus for communicating signals in a wireless network; and
a memory communicatively coupled with the at least one processor and/or the RF transceiver via the bus;
wherein the at least one processor and the memory are configured to:
identify a failure during DPD training for the RF transceiver;
determine one or both of a severity of the failure or a type of the failure;
perform self-recovery from the failure to continue the DPD training based at least in part on one or both of the severity of the failure or the type of the failure.

18. The apparatus of claim 17, wherein the at least one processor and the memory are configured to determine the severity of the failure as one of an iteration failure during an iteration of the DPD training, or a persistent failure, a serious failure, or a critical failure in a plurality of DPD training iterations.

19. The apparatus of claim 17, wherein the at least one processor and the memory are configured to determine a type of self-recovery to perform based at least in part on the severity of the failure.

20. An apparatus for resolving failures in digital pre-distortion (DPD) training in wireless communications, comprising:
means for identifying a failure during DPD training for a transceiver;
means for determining one or both of a severity of the failure or a type of the failure;
means for performing self-recovery from the failure to continue the DPD training based at least in part on one or both of the severity of the failure or the type of the failure.
